(19) United States
(12) Patent Application Publication
(10) Pub. No.: US 2017/0071365 A1
(43) Pub. Date: Mar. 16, 2017

(54) FIXING PIECE CONNECTING TO A PHOTO FRAME BACKING BOARD AND MANUFACTURING METHOD THEREOF

(71) Applicant: DONGGUAN JUNXIN HARDWARE MANUFACTURE CO., LTD., Guangdong (CN)

(72) Inventor: Junwei LI, Guangdong (CN)

(21) Appl. No.: 15/359,629

(22) Filed: Nov. 23, 2016

Related U.S. Application Data
(62) Division of application No. 15/008,482, filed on Jan. 28, 2016.
Application No. 15/008,482 is a continuation-in-part of application No. PCT/CN2014/082964, filed on Jul. 25, 2014.

(30) Foreign Application Priority Data
Jul. 29, 2013 (CN) 201320457478.8

(51) Int. Cl. A47G 1/06; F16B 15/02; A47G 1/16

(52) U.S. Cl. CPC A47G 1/06; A47G 1/162; F16B 15/02; A47G 2001/0677

(57) ABSTRACT

A fixing piece connecting to a photo frame backing board, comprising a rotating portion and a fixed portion connected with a photo frame. One end of the rotating portion is connected with the fixed portion. Another end is connected with a fixed body used for fixing the photo frame; the rotating portion is formed by engaging and connecting a concave rotational surface and a convex rotational surface. A method for manufacturing the aforementioned fixing piece connecting to a photo frame backing board is also provided.

### CROSS REFERENCES TO RELATED APPLICATIONS

The present invention is a divisional application of U.S. nonprovisional application Ser. No. 15/008,482, which is a continuation-in-part application of PCT/CN2014/082964.

### BACKGROUND OF THE INVENTION

The present invention relates to a photo frame production technology, and particularly relates to a fixing piece connecting to a photo frame backing board and a manufacturing method thereof.

Photo frame is a product in which a picture is put for viewing in everyday life. It is generally used by placing on a horizontal surface (like table tops) or hanging on a vertical surface (like a wall). Back side of the photo frame backing board is usually connected with a fixing piece in order to realize the aforementioned method of use. For example, a supporting frame is set to support and fix a photo frame on a horizontal surface, or a hanging piece is connected so that the photo frame can be hung on a projection of a vertical surface through the hanging piece; the fixing piece connecting to the backing board often needs to meet certain requirements: 1, securely connected with the backing board while being able to rotate easily and flexibly according to different conditions of use, so as to mount and use properly in coordination with the mounting conditions; 2, due to the large number of fixing pieces to be mounted, convenient operation, low production cost and high efficiency are required in connections. The existing form of fixing pieces connecting to the backing board usually adopts the form of screw connection or riveting. In the form of screw connection, screw directly passes through the fixing piece and is screwed into the backing board (as shown in FIG. 1). This method is simple in structure and convenient in operation, but difficult to attain the requirements of both secure connection and flexible rotation at the same time. If the screw is tight, the fixing piece can hardly rotate. But if the screw is not tight enough, it becomes loose easily. Also, in this method, it is difficult to achieve consistency in the connection of each fixing piece. The demand for standardization cannot be satisfied; connection in the form of riveting is shown in FIG. 2. Specifically, the backing board is opened with a hole first, then a rivet passes through the opening on the fixing piece and the opening on the backing board manually. After that, the rivet is crimped on another side of the backing board to achieve rivet connection between the fixing piece and the backing board. This method has better connection stability and is less easy to be loose, but obvious disadvantages also exist; since the backing board has to be opened with a hole first, followed by the need to pass a rivet through the fixing piece and backing board manually and then fix by crimping, the operation procedures are relatively complicated with high labor intensity and low productivity; it is also more difficult to achieve consistency in tightness of connection of each fixing piece (rotation is affected if connection is tight); so different kinds of disadvantages exist in all connections of the existing fixing pieces, which cannot meet the large-scale and high-quality production requirements.

### BRIEF SUMMARY OF THE INVENTION

The present invention aims at overcoming the shortcomings and deficiencies in the prior art and providing a fixing piece connecting to a photo frame backing board. The fixing piece is simple and reasonable in structure, highly mechanized, convenient for operation, with good consistency in mounting and high production efficiency, and can better attain the requirements of secure connection and flexible rotation.

Another aim of the invention is to provide a manufacturing method of the aforementioned fixing piece connecting to the photo frame backing board.

Aims of the present invention are realized by the following technical scheme: A fixing piece connecting to a photo frame backing board comprises a rotating portion and a fixed portion connected with a photo frame. One end of the rotating portion is connected with the fixed portion. Another end of the rotating portion is connected with a fixing body used for fixing the photo frame; the rotating portion is formed by engaging and connecting a concave rotational surface and a convex rotational surface.

The convex rotational surface of the rotating portion is connected with the fixed portion. The concave rotational surface is connected with the fixing body. A through hole is provided at a center of the concave rotational surface. The fixed portion connected with the convex rotational surface passes through the through hole. The convex rotational surface is sleeved within the concave rotational surface so as to be fitted and connected together. The concave rotational surface limits the convex rotational surface so that the convex rotational surface can only rotate within and relative to the concave rotational surface but cannot slip off from the concave rotational surface; a specific implementation of the concave rotational surface limiting the convex rotational surface is as follows: after the concave rotational surface has sleeved the convex rotational surface, an outer side of the concave rotational surface is processed to form a flange wherein an inner diameter of the flange smaller than an outer diameter of the convex rotational surface so that the convex rotational surface can only rotate within and relative to the concave rotational surface but cannot slip off from the concave rotational surface. This structure has the effects that the convex rotational surface and the concave rotational surface are fitted and connected with each other so that they will not disengage easily. In addition, the flange arranged to limit the position of the convex rotational surface connected with the fixed portion results in a more secure and reliable connection so that the convex rotational surface and the concave rotational surface can no longer disengage.

The concave rotational surface of the rotating portion is connected with the fixed portion. The convex rotational surface is connected with the fixing body. The convex rotational surface is sleeved within the concave rotational surface. The concave rotational surface enables position limiting of the convex rotational surface, so that the convex rotational surface can only rotate within and relative to the concave rotational surface but cannot slip off from the concave rotational surface.

The convex rotational surface of the rotating portion is connected with the fixed portion. The concave rotational surface is connected with the fixing body. The convex rotational surface is sleeved within the concave rotational surface. The concave rotational surface enables position limiting of the convex rotational surface, so that the convex rotational surface can only rotate within and relative to the concave rotational surface but cannot slip off from the concave rotational surface.

The concave rotational surface can be formed as an annular inward concave slot, multiple sections of arc-shaped inward concave slot or a plurality of inward concave engagement points; the convex rotational surface can be formed as an annular flange, multiple sections of arc-shaped flanges or a plurality of convex engagement points; various types of concave rotational surface and convex rotational surface fit and connect correspondingly, meeting the following conditions at the same time: the concave rotational surface can keep the position of the convex rotational surface, so that the convex rotational surface can only rotate within and relative to the concave rotational surface but cannot slip off from the concave rotational surface.

The aforementioned concave rotational surface and convex rotational surface fit and connect to each other in various forms, preferably comprising the several forms as follows:

(1) The concave rotational surface being an annular inward concave slot while the convex rotational surface being an annular flange; both rotational surfaces in this form of connection are formed as being complete and continuously annular.

(2) The concave rotational surface being multiple sections of arc-shaped inward concave slot while the convex rotational surface being multiple sections of arc-shaped flanges; both rotational surfaces in this form of connection are not formed as being completely and continuously annular. Materials can be relatively saved. Also, if scrap or dirt hindering relative rotation exists between the two rotational surfaces this form of structure allows the scrap or dirt to be removed out of the gaps between the arc-shaped sections easily.

(3) The concave rotational surface being an annular inward concave slot while the convex rotational surface being a plurality of convex engagement points; the plurality of convex engagement points are circumferentially and evenly distributed; this form of structure is much simpler. Materials can be significantly reduced. It is very easy to remove the scrap or dirt which exist between the rotational surfaces and hinder relative rotation.

(4) The concave rotational surface being a plurality of inward concave engagement points while the convex rotational surface being an annular flange; the plurality of inward concave engagement points are circumferentially and evenly distributed; this form of structure is much simpler. Materials can be significantly reduced. It is very easy to remove the scrap or dirt which exist between the rotational surfaces and hinder relative rotation.

(5) The concave rotational surface being multiple sections of arc-shaped inward concave slots while the convex rotational surface being a plurality of convex engagement points. Both the arc-shaped inward concave slots and the convex engagement points are circumferentially and evenly arranged. A width of each of the convex engagement points is larger than a width of each gap between adjacent arc-shaped inward concave slots to ensure that the convex engagement points do not slip off through the gaps; this form of structure is the most material-saving, and is the easiest to remove the scrap or dirt which exist between the rotational surfaces and hinder relative rotation.

(6) The concave rotational surface being a plurality of inward concave engagement points while the convex rotational surface being multiple sections of arc-shaped flanges. Both the plurality of inward concave engagement points and the arc-shaped flanges are circumferentially and evenly arranged. A width of each of the inward concave engagement points is larger than a width of each gap between adjacent arc-shaped flanges to ensure that the inward concave engagement points do not slip off the gap this form of structure is also the most material-saving, and is also the easiest to remove the scrap or dirt which exist between the rotational surfaces and hinder relative rotation.

The fixed portion connected with the photo frame can be sharp thorns, which can be inserted and fixedly connect with the photo frame backing board; the sharp thorns can be circumferentially and evenly arranged in a petaloid form to provide a more even fixing effect on the circumference.

The fixing body used for fixing the photo frame can be in various existing forms, such as a hanging ring, a hanging strip, a supporting frame, a press strip, a press block, a clamping strip, a clamping block, etc.

A manufacturing method of the aforementioned fixing piece connecting to the photo frame backing board comprises the following steps:

(1) making a fixing body used for fixing a photo frame, and making a concave rotational surface or a convex rotational surface in an proper position of the fixing body by punching;

(2) making a fixed portion connected with the photo frame, processing end of the fixed portion into a structure connected with the photo frame, and processing another end of the fixed portion into a convex rotational surface or a concave rotational surface by punching;

(3) engaging the concave rotational surface or convex rotational surface of the fixing body with the convex rotational surface or concave rotational surface of the fixed portion.

A manufacturing method of the aforementioned fixing piece connecting to the photo frame backing board may comprise the following steps:

(1) making a fixing body used for fixing a photo frame, and making a circular straight edge in a proper position of the fixing body by punching;

(2) making a fixed portion connected with the photo frame, processing one end of the fixed portion into a structure connected with the photo frame and making a circular straight edge at another end of the fixed portion by punching;

(3) engaging the circular straight edge of the fixing body and the circular straight edge of fixed portion, then processing the circular straight edge of the fixing body into a concave rotational surface or a convex rotational surface by punching; also, processing the circular straight edge of the fixed body correspondingly into a convex rotational surface or a concave rotational surface by punching, thus forming a structure which fit and engage the circular straight edges together. Since this method does not require a separate step for engagement, processing speed is faster. Also, possible damage to the concave rotational surface or convex rotational surface in the engagement process is avoided. Processability is better, deficiency rate can be greatly reduced. The large-scale and high-quality modern production requirements can be met.

A manufacturing method of the aforementioned fixing piece connecting to the photo frame backing board may comprise the following steps:

(1) making the fixing body used for fixing the photo frame, making a concave rotational surface in a proper position of the fixing body by punching, and opening a hole at a center of the concave rotational surface;

(2) making the fixed portion connected with the photo frame, processing one end of the fixed portion into a structure connected with the photo frame and processing another end of the fixed portion into a convex rotational surface by punching;

(3) passing the fixed portion through the opening of the concave rotational surface so that the convex rotational surface is in contact with the concave rotational surface of the fixing body;

(4) Punching inwardly from an outer side of the concave rotational surface so that a flange is formed on an inner side of the concave rotational surface, wherein an inner diameter of the flange is smaller than an outer diameter of the convex rotational surface, thereby forming a structure which realizes engagement of the convex rotational surface and the concave rotational surface wherein position limiting of the convex rotational surface is realized by the flange.

The present invention operates according to the following working principle: a rotating portion and a fixed portion connecting the photo frame relatively independent to each other are formed at the same time on the fixing piece connecting to the photo frame backing board, wherein the fixed portion and the photo frame backing board are connected with each other so that the entire fixing piece is securely connected to a back side of the photo frame. A relatively independent rotating portion formed at a fixing body for fixing the photo frame can rotate flexibly according to application requirement. Rotation of the fixing body does not affect the securing strength of the fixing piece. Securing of the fixed portion also has no effect on the rotation of the fixing body. Thus, this can better meet the strict requirement for the fixing piece to connect to the photo frame backing board.

The present invention has the following advantages and effects over the prior art:

(1) simple and reasonable structure; a rotating portion and a fixed portion relatively independent to each other are formed at the same time on the fixing piece connecting to the photo frame backing board of the present invention. the rotating portion formed at the fixing body used for fixing the photo frame can rotate flexibly according to application requirement. Securing of the fixed portion also has no effect on rotation of the fixing body. This can ensure a secure connection with the backing board and also the easy and flexible rotation according to the use of state, thereby overcoming the problem of incompatibility of fixed connection and flexible rotation existing in the current form of connection using screw and rivet. Therefore, the structure is very reasonable and effective.

(2) Convenient processing; the structure of the fixing piece in the present invention is designed entirely for automatic machine production. In the production process, both the fixing body with rotational surface and the fixed portion with rotational surface can be processed at the same time. After processing these two parts, fitting and assembling can be done in the same mold or by being automatically transported to specialized mounting equipment; the whole production process can achieve full automation without human intervention, so the production cost is low and the processing efficiency is high, which is particularly suited for the large-scale production processing requirements.

(3) Ease of use; the biggest advantage of the fixing piece of the present invention is that it is very simple and quick to use. When mounting with a photo frame backing board, pressing the fixed portion to be connected with a photo frame into the photo frame backing board is all that is required. Unlike screw connection, for example, there is no need for a screw-in process that takes a long time. Rivet connection that requires a series of tedious steps such as drilling, manual nailing of rivet, riveting are avoided. Mounting speed improves significantly. In particular, manual steps are minimized, so workload is greatly reduced. Good consistency of product quality is achieved. The production demand for standardization can be better satisfied. Through test and comparison, operation time for mounting by screw connection is 15 seconds on average; operation time for mounting by rivet connection is 18 seconds on average; and operation time for mounting and connecting by the fixing piece of the present invention is just 2 seconds on average; thus, operating speed of the present invention is increased by 7.5˜9 times. Production efficiency is improved significantly.

### BRIEF DESCRIPTION OF THE DRAWINGS

FIG. 1 is an illustrative diagram showing the use of a screw for connecting a fixing piece according to prior art.

FIG. 2 is an illustrative diagram showing the use of a general rivet for connecting a fixing piece according to prior art.

FIG. 3 is a diagram showing the structure of the fixing piece of the present invention.

FIG. 4 is diagram showing the working principle of the fixing piece as shown in FIG. 3.

FIG. 5 is another diagram showing the structure of the fixing piece of the present invention.

FIG. 6 is still another diagram showing the structure of the fixing piece of the present invention.

FIG. 7 is a further diagram showing the structure of the fixing piece of the present invention.

FIG. 8 is a diagram showing the fifth structure the fixing piece of the present invention.

FIG. 9 is a diagram showing the sixth structure of the fixing piece of the present invention.

FIG. 10 is a diagram showing the seventh structure of the fixing piece of the present invention.

FIG. 11 is a diagram showing the eighth structure of the fixing piece of the present invention.

FIG. 12 is a diagram showing the ninth structure of the fixing piece of the present invention.

FIG. 13 is a diagram showing the tenth structure of the fixing piece of the present invention.

FIG. 14 is a diagram showing the eleventh structure of the fixing piece of the present invention.

FIG. 15 is a diagram showing the twelfth structure of the fixing piece of the present invention.

FIG. 16 is another diagram showing the twelfth structure of the fixing piece of the present invention.

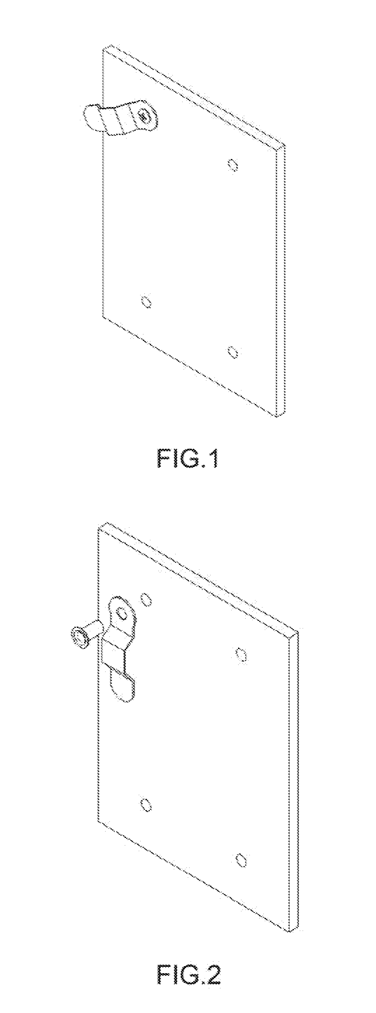

### DETAILED DESCRIPTION OF THE INVENTION

The present invention is further described in detail below with reference to the accompanying drawings. However, the embodiments of the present invention are not limited thereto.

### Embodiment 1

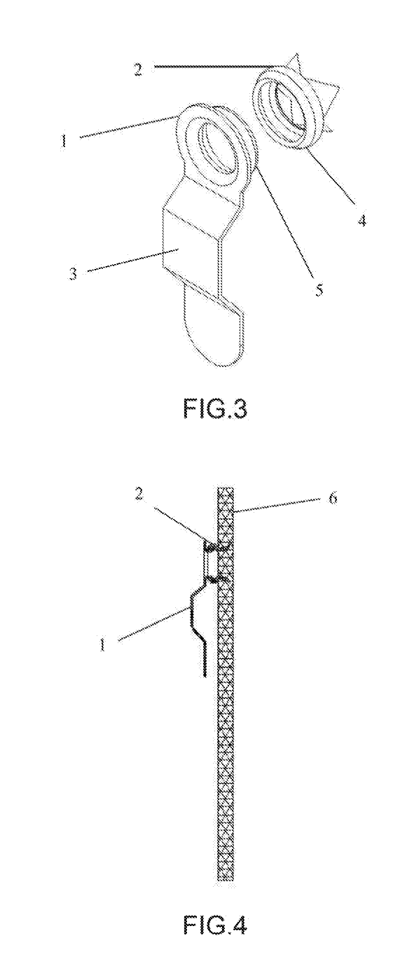

FIG. 3 illustrates a specific embodiment of the present invention. As seen in FIG. 3, the present fixing piece connecting to a photo frame backing board comprises a rotating portion 1 and a fixed portion 2 connected with a photo frame. One end of the rotating portion 1 is connected with the fixed portion 2. Another end of the rotating portion 1 is connected with a fixing body 3 used for fixing the photo frame; the rotating portion 1 is formed by engaging and connecting a concave rotational surface 4 and a convex rotational surface 5; the concave rotational surface 4 is an annular inwardly recessed slot. The convex rotational surface 5 is an annular flange. Both rotational surfaces engaged as such both form a complete annular shape.

The concave rotational surface 4 of the rotating portion 1 is connected with the fixed portion 2. The convex rotational surface 5 is connected with the fixing body 3. The convex rotational surface 5 is sleeved by the concave rotational surface 4. The concave rotational surface 4 limits the convex rotational surface 5 so that the convex rotational surface 5 can only rotate relative to the concave rotational surface 4 but cannot slip off from the concave rotational surface 4. The fixed portion 2 connected with the photo frame is formed as sharp thorns, which can insert into and fixedly connect with the photo frame backing board; the sharp thorns can be circumferentially and evenly distributed in a petaloid form to provide a more even fixing effect on along the circumference; the fixing body 3 is a backing board plate used for fixing the photo frame. The whole connection is shown in FIG. 4. As seen in FIG. 4, sharp thorns are inserted in the photo frame backing board 6 allowing the fixed piece 2 to secure to the photo frame. The rotating portion 1 formed by engaging and connecting the concave rotational surface and the convex rotational surface can rotate freely without restrictions. Position of the photo frame is fixed by adjusting the backing board plate to a proper position.

A manufacturing method of the aforementioned fixing piece connecting the photo frame backing board comprises the following steps:

(1) making a backing board plate used for fixing a photo frame and producing a convex rotational surface on one side thereof by punching;

(2) making sharp thorns to be connected with the photo frame, processing one side of the sharp thorns so that the sharp thorns are circumferentially and evenly distributed in a petaloid form; pressing said side of the sharp thorns into the photo frame to fixedly connect the sharp thorns with the photo frame; and producing a concave rotational surface at another side of the sharp thorns opposite to the side of the sharp thorns pressed into the photo frame.

(3) engaging the concave rotational surface connected with the sharp thorns and the convex rotational surface on the backing board plate to complete the manufacturing of the present fixing piece.

### Embodiment 2

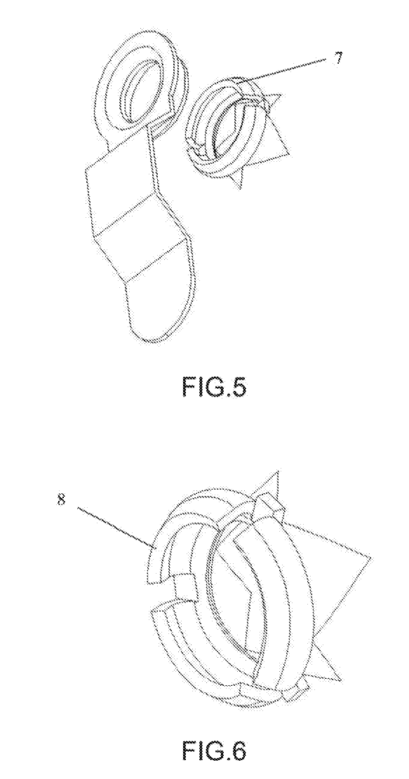

FIG. 5 illustrates another specific structure of the present invention. As seen in FIG. 5, this embodiment is the same as Embodiment 1 except the following feature: the concave rotational surface connected with the sharp thorns is formed in a circular shape by two sections each being an arc-shaped inward concave slot 7. This form of rotational surface is not in a complete annular shape. Materials can be relatively saved. Also, if scrap or dirt hindering relative rotation exists between the two rotational surfaces, this form of structure allows the scrap or dirt to be removed easily through the gaps between the arc-shaped inward concave slots.

### Embodiment 3

FIG. 6 illustrates another specific structure of the present invention. As seen in FIG. 6, this embodiment is the same as Embodiment 2 except the following feature: the concave rotational surface connected with the sharp thorns is formed in a circular shape by three sections each being an arc-shaped inward concave slot 8.

### Embodiment 4

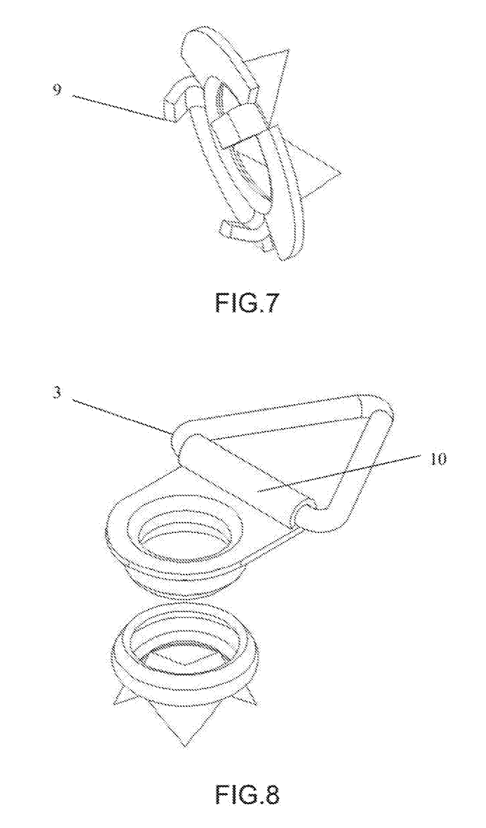

FIG. 7 illustrates a further specific structure of the present invention. As seen in FIG. 7, this embodiment is the same as Embodiment 1 except the following features: the concave rotational surface connected with the sharp thorns is formed as three inward concave engagement points 9 while convex rotational surface is an annular flange; the inward concave engagement points are circumferentially and evenly distributed; this form of structure is much simpler. Materials can be significantly reduced. It is very easy to remove the scrap or dirt which exists between the rotational surfaces and hinders relative rotation.

### Embodiment 5

FIG. 8 illustrates the fifth specific structure of the present invention. As seen in FIG. 8, this embodiment is the same as Embodiment 1 except the following features: the fixing body 3 is a triangular hook. The annular flange is connected with one side of the triangular hook through a rolled edge 10.

### Embodiment 6

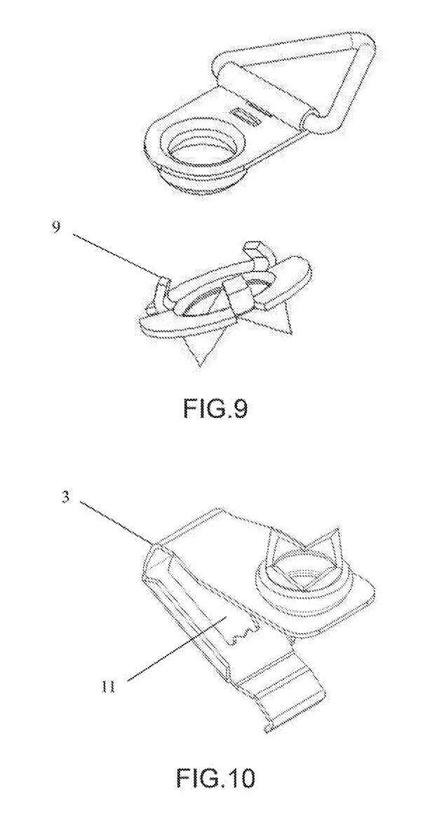

FIG. 9 illustrates the sixth specific structure of the present invention. As seen in FIG. 9, this embodiment is the same as Embodiment 5 except the following feature: the concave rotational surface connected with the sharp points is formed as three inward concave engagement points 9.

### Embodiment 7

FIG. 10 illustrates the seventh specific structure of the present invention. As seen in FIG. 10, this embodiment is the same as Embodiment 1 except the following features: the fixing body 3 used for fixing the photo frame is an elastic clamping plate. The elastic clamping plate is provided with a hole 11.

### Embodiment 8

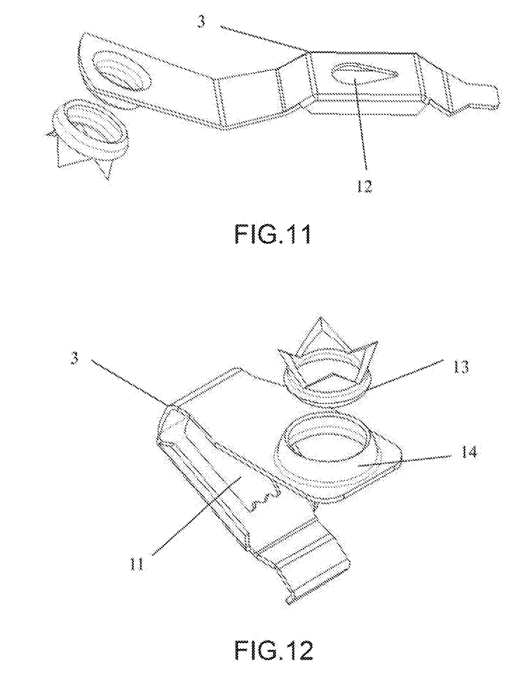

FIG. 11 illustrates the eighth specific structure of the present invention. As seen in FIG. 11, this embodiment is the same as Embodiment 1 except the following features: the fixing body 3 used for fixing photo frame an elastic plate. The elastic plate is provided with a hole 12.

### Embodiment 9

FIG. 12 illustrates the ninth specific structure of the present invention. As seen in FIG. 12, this embodiment is the same as Embodiment 1 except the following features: sharp thorns of the fixed portion are connected with an annular flange 13. The fixing body is connected with an annular inward concave slot 14. The annular flange 13 is sleeved by the annular inward concave slot 14. The annular inward concave slot 14 limits a position of the annular flange 13; the fixing body 3 is an elastic clamping plate. The elastic clamping plate is provided with a hole 11.

A manufacturing method of the aforementioned fixing piece connecting the photo frame backing board comprises the following steps:

(1) making the elastic clamping plate used for fixing a photo frame and producing a circular straight edge at an end thereof;

(2) making the fixed portion to be connected with the photo frame, processing one side of the fixed portion into sharp thorns to be connected with the photo frame, and producing a circular straight edge at another side of the fixed portion by punching;

(3) engaging the circular straight edge of the elastic clamping plate and the circular straight edge of the fixed portion, then making the circular straight edge of the elastic clamping plate into a concave rotational surface by punching in the meantime, making the circular straight edge of the fixed portion correspondingly into a convex rotational surface by punching to directly form a structure which fit and engage the concave rotational surface and the convex rotational surface together.

### Embodiment 10

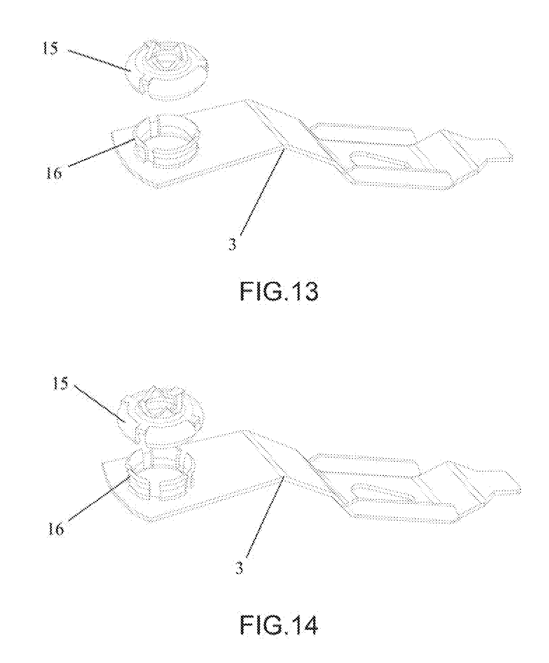

FIG. 13 illustrates the tenth specific structure of the present invention. As seen in FIG. 13, this embodiment is the same as Embodiment 1 except the following features: convex rotational surface 15 connected with sharp thorns is in a circular shape formed by three sections each being an arc-shaped flange. Concave rotational surface 16 connected with the fixing body 3 is in a circular shape formed by three sections each being an arc-shaped outward concave slot. These rotational surfaces are not formed as being completely and continuously annular. Materials can be relatively saved. Also, if scrap or dirt hindering relative rotation exists between the two rotational surfaces, this form of structure allows the scrap or dirt to be removed out of the gaps between the re-shaped sections.

### Embodiment 11

FIG. 14 illustrates the eleventh specific structure of the present invention. As seen in FIG. 14, this embodiment is the same as Embodiment 1 except the following features: convex rotational surface 15 connected with sharp thorns is in a circular shape formed by four sections each being an arc-shaped flange. Concave rotational surface 16 connected with the fixing body 3 is in a circular shape formed by five sections each being an arc-shaped outward concave slot. These rotational surfaces are not formed as being completely and continuously annular. Materials can be relatively saved. Also, if scrap or dirt hindering relative rotation exists between the two rotational surfaces, this form of structure allows the scrap or dirt to be removed out of the gaps between the arc-shaped sections.

### Embodiment 12

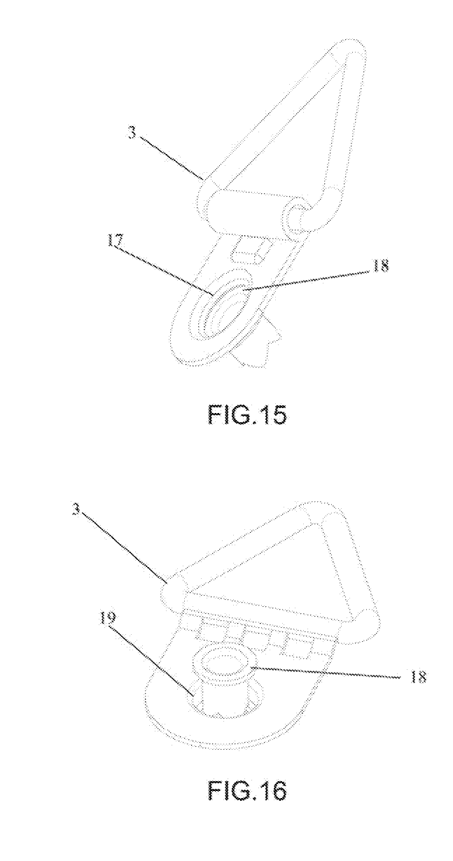

FIGS. 15 and 16 respectively illustrate the twelfth specific structure of the present invention. This embodiment is the same as Embodiment 1 except the following features: convex rotational surface 18 of the rotating portion is connected with the sharp thorns. Concave rotational surface 19 is connected with the fixing body. A through hole is provided at the center of the concave rotational surface 19. After the sharp thorns connected with the convex rotational surface 18 pass through the through hole, the convex rotational surface 18 behind is in contact with the concave rotational surface 19. An outer side of the concave rotational surface 19 is subject to punching process to form a flange 17 on an inner side of the concave rotational surface 19. An inner diameter of the flange 17 is smaller than an outer diameter of the convex rotational surface 18, thereby forming a structure which allows position limiting of the convex rotational surface 18 by the concave rotational surface 19, so that the convex rotational surface 18 can only rotate relative to the concave rotational surface 19 but cannot slip off from the concave rotational surface 19; this structure has the effects that the convex rotational surface 18 and the concave rotational surface 19 are fitted and connected with each other so that they will not disengage easily. In addition, a flange 17 is arranged to limit the position of the convex rotational surface 18 connected with the fixed portion 2, resulting in a more secure and reliable connection so that they can no longer disengage.

The above embodiment is a more preferred description of the present invention. However, description of the present invention is not limited by the above embodiment. Any other changes, modification, substitution, combinations, simplification and equivalents not deviated from the essence and principle of the present invention are equivalent replacement and they all fall into the scope of protection of the present invention.

What is claimed is:

1. A fixing piece connecting to a photo frame backing board, comprising a rotating portion and a fixed portion connected with a photo frame; one end of the rotating portion is connected with the fixed portion; another end of the rotating portion is connected with a fixing body used for fixing the photo frame;
the rotating portion is formed by engaging and connecting a concave rotational surface and a convex rotational surface; the convex rotational surface of the rotating portion is connected with the fixed portion; the concave rotational surface is connected with the fixing body; a through hole is provided at a center of the concave rotational surface; the fixed portion connected with the convex rotational surface passes through the through hole; the convex rotational surface is sleeved within the concave rotational surface so as to be fitted and connected together; the concave rotational surface limits the convex rotational surface so that the convex rotational surface is only capable of rotating within and relative to the concave rotational surface but not able to slip off from the concave rotational surface; the concave rotational surface limits the convex rotational surface by the following configuration: after the concave rotational surface has sleeved the convex rotational surface, an outer site of the concave rotational surface is processed to form a flange wherein an inner diameter of the flange is smaller than an outer diameter of the convex rotational surface.

2. The fixing piece connecting to a photo frame back in board as described in claim 1, wherein the concave rotational surface is formed as an annular inward concave slot, multiple sections of arc-shaped inward concave slots or a plurality of inward concave engagement points; the convex rotational surface is formed as an annular flange, multiple sections of arc-shaped flanges or a plurality of convex engagement points; various formations of the concave rotational surface and the convex rotational surface fit and connect correspondingly, meeting the following conditions: the concave rotational surface keeps limiting a position of the convex rotational surface, so that the convex rotational surface is only capable of rotating within and relative to the concave rotational surface but not able to slip off from the concave rotational surface.

3. The fixing piece connecting to a photo frame backing board as described in claim 2, wherein the concave rotational surface and convex rotational surface are fitted and connected to each other according to any one of the following forms:
(1) the concave rotational surface being an annular inward concave slot while the convex rotational surface being an annular flange;
(2) the concave rotational surface being multiple sections of arc-shaped inward concave slots while the convex rotational surface being multiple sections of arc-shaped flanges;
(3) the concave rotational surface being an annular inward concave slot while the convex rotational surface being a plurality of convex engagement points; the plurality of convex engagement points are circumferentially and evenly distributed;
(4) the concave rotational surface being a plurality of inward concave engagement points while the convex rotational surface being an annular flange;
(5) the concave rotational surface being multiple sections of arc-shaped inward concave slots while the convex rotational surface being a plurality of convex engagement points; both the arc-shaped inward concave slots and the convex engagement points are circumferentially and evenly arranged; a width of each of the convex engagement points is larger than a width of each gap between adjacent arc-shaped inward concave slots to ensure that the convex engagement points do not slip off through each of the gap;
(6) the concave rotational surface being a plurality of inward concave engagement points while the convex rotational surface being multiple sections of arc-shaped flanges; both the plurality of inward concave engagement points and the arc-shaped flanges are circumferentially and evenly arranged;
a width of each of the inward concave engagement points is larger than a width of each gap between adjacent arc-shaped flanges to ensure that the inward concave engagement points do not slip off through each of the gap.

4. The fixing piece connecting to a photo frame backing board as described in claim 1, wherein the fixed portion connected with the photo frame is sharp thorns, which are inserted and fixedly connect with the photo frame backing board; the sharp thorns are circumferentially and evenly arranged in a petaloid form.

5. The fixing piece connecting to a photo frame backing board as described in claim 1, wherein the fixing body used for fixing the photo frame is a hanging ring, a hanging strip, a supporting frame, a press strip, a press block, a clamping strip or a clamping block.
